(19) United States
(12) Patent Application Publication
(10) Pub. No.: US 2007/0201840 A1
(43) Pub. Date: Aug. 30, 2007

(54) Hard disc recorder

(75) Inventors: Yasuo Masaki, Osaka (JP); Hirono Tsubota, Osaka (JP); Akinori Okazaki, Osaka (JP); Sadanori Murakami, Osaka (JP); Yukiyoshi Sasao, Osaka (JP); Masahiro Takeshita, Osaka (JP); Masao Kokado, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/702,512

(22) Filed: Feb. 6, 2007

(30) Foreign Application Priority Data
Feb. 7, 2006 (JP) 2006-029830

(51) Int. Cl. H04N 5/00

(52) U.S. Cl. 386/125

(57) ABSTRACT

A hard disc recorder (1) comprises an imaging unit (8) that takes an image of a predetermined imaging area in front of the hard disc recorder (1), a user identification unit (3a) that calculates a feature quantity of a user who operates the hard disc recorder based on image data by performing facial recognition, and identifies the user who operates the hard disc recorder, a user attribution adding unit (3b) that adds the feature quantity calculated by the user identification unit (3a) to a data file of TV program to be recorded in the hard disc recorder when a user instructs to record a TV program. Thereby, information relating to the user who operates the hard disc recorder (1) is automatically added to the data file of TV program as an attribution of the user who records the TV program.

### BACKGROUND OF THE INVENTION

1. Field of the Invention

The present invention relates to a hard disc recorder which records audio and visual signals such as television (TV) broadcast signals into a hard disc drive as digital data, reads out the digital data from the hard disc drive and outputs the digital data to an external display apparatus.

2. Description of the Related Art

In recent years, a hard disc recorder on which a hard disc drive is mounted is widely used as a recording/reproducing apparatus for receiving, recording and reproducing TV broadcast programs. The hard disc recorder records the TV broadcast signals into the hard disc drive as digital data, reads out the digital data from the hard disc drive and outputs the digital data to an external display apparatus.

In such a hard disc recorder, since recordable capacity of the hard disc drive has a limitation, it is necessary to erase unnecessary data file of TV program so as to secure the recordable capacity of the hard disc drive when a TV program is newly recorded. The conventional hard disc recorder, however, has a disadvantage that a data file of TV program which was recorded by a user might be erased or edited erroneously by another user, so that the user who recorded the TV program cannot reproduce and view the recorded TV program. Although the conventional hard disc recorder enables to prevent erroneous erasure or edit by another user with adding user attribution such as a password to the data file of TV program. However, the operation to add the user attribution such as password to the data file of TV program needs complex and troublesome operation.

Japanese Laid-Open Patent Publication No. 2001-128076 discloses a conventional TV receiver which performs facial recognition of a user with using an image of the user taken by a camera so as to prevent missing of recording or reproducing of the TV programs. Japanese Laid-Open Patent Publication No. 2001-61115 discloses a conventional recorder which performs facial recognition of a user so as to record TV programs having predetermined attribution listed in an electronic TV program guide for each identified user. Although these TV receiver and recorder perform facial recognition of the user, they cannot prevent erroneous erasure or edit of the TV programs by a user who did not record the TV programs.

Japanese Laid-Open Patent Publication No. 2000-175117 discloses another conventional TV receiver that identifies a user who views a TV program by facial recognition, and restricts the reproduction of the TV program when information of the identified user previously registered conforms to a predetermined parameter of the TV program. The TV receiver, however, cannot treat data files of TV programs with reproducing or erasing. Furthermore, the TV receiver needs to register the information of each user who uses the TV receiver, previously.

### SUMMARY OF THE INVENTION

A purpose of the present invention is to provide a hard disc recorder which enables to add attribution of information of a user to a data file of TV program easily so that usability of the hard disc recorder is improved when the hard disc recorder is used by a plurality of users.

A hard disc recorder in accordance with an aspect of the present invention records digital audio and video signals into a hard disc drive, reproduces the digital audio and video signals from the hard disc drive, and outputs the digital audio and video signals to an external monitor display apparatus. The hard disc recorder comprises: an imaging unit that takes an image of a predetermined imaging area in front of the hard disc recorder and outputs an image data of the image; a user identification unit that calculates a feature quantity of a user who operates the hard disc recorder based on the image data by performing facial recognition, and identifies the user who operates the hard disc recorder; a user attribution adding unit that adds the feature quantity calculated by the user identification unit to a data file of TV program to be recorded in the hard disc recorder when a user instructs to record a TV program; and a file management unit that manages data files of TV programs recorded in the hard disc recorder corresponding to the operation by the user.

According to such a configuration, when a user instruct to record a TV program, a feature quantity of the user is calculated by the user identification unit on the basis of an image data of the user taken by the imaging unit, and the user attribution adding unit automatically adds information of the feature quantity of the user who instruct to record the TV program to, for example, a header of a data file of the TV program as an attribution of the user, with no requirement of operation to the user so as to add the attribution of the user. Therefore, even when the hard disc recorder is used by a plurality of users, it is possible to manage the data files of TV programs recorded in the hard disc recorder for each user, easily.

Furthermore, the information of the user such as the feature quantity of the user is included in each data file of TV program, so that it is no need to form a database to manage the user information, and thereby, the configuration of the hard disc recorder 1 can be simplified. Still furthermore, when the data file of TV program recorded in the hard disc recorder is transmitted to another recording medium, the information of the user can be used. Still furthermore, even when the user instruct to erase a TV program recorded in the hard disc recorder, the user identification unit compares the feature quantity of the user with the feature quantity of the user included in the data file of the TV program, and when the feature quantities of the users do not conform to each other, the file management unit may not erase the data file of the TV program from the hard disc recorder. Thus, it is possible to prevent that any data file of TV program recorded in the hard disc recorder is erroneously erased by a user other than the user who records the TV program.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a block diagram showing an example of a hard disk recorder in accordance with an embodiment of the present invention;

FIG. 2 is a flowchart showing a normal recording operation of the above hard disk recorder;

FIG. 3 is a flowchart showing a preset recording operation of the above hard disk recorder; and

FIG. 4 is a flowchart showing an operation to erase a data file of TV program recorded by a file management unit of the above hard disc recorder.

### DETAILED DESCRIPTION OF THE EMBODIMENT

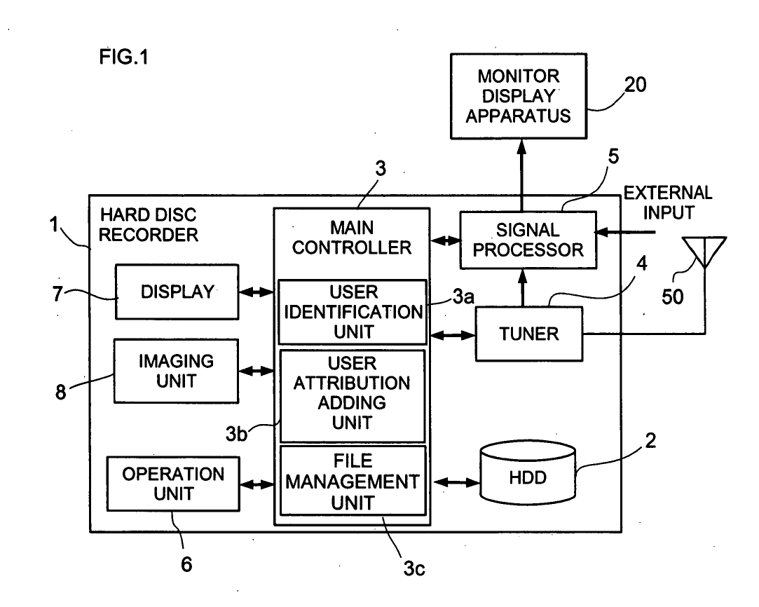

A hard disc recorder in accordance with an embodiment of the present invention is described with reference to the figures. FIG. 1 shows a block configuration of the hard disk recorder in accordance with this embodiment.

The hard disk recorder 1 comprises a hard disc drive 2 inside, and has recording and reproducing functions. In the recording function, the hard disc recorder 1 performs recording operation with receiving audio and visual signals such as TV broadcast signals inputted through an antenna 50 and recording the received signals as digital data into the hard disc drive 2. In the reproducing function, the hard disc recorder 1 performs reproducing operation with reading the digital data recorded in the hard disc drive 2 and outputting the read data to an external monitor display apparatus 20. The hard disc recorder 1 further has a time shift function that enables to reproduce a TV program from the beginning without waiting the end of the TV program while recording the TV program.

The hard disc recorder 1 further comprises a tuner 4 that receives analogue or digital TV broadcast signals of a desired channel among TV broadcast signals which are delivered from a plurality of TV stations and inputted through the antenna 50, and outputs video signals (including audio signals and visual signals). The video signals outputted from the tuner 4 or video signals inputted from external AV (Audio and Visual) apparatus through external input terminals (not shown) are converted to digital signals by a signal processor 5. The signal processor 5 further converts the digital signals to video signals so as to be outputted to the monitor display apparatus 20. An operation unit 6, which is operated by a user, for example, to select a channel of a TV program to be received, to input instruction to start recording or reproducing the TV program and to input a preset time to start recording the TV program, is provided on a front panel of the hard disc recorder 1 or independently provided from a main body of the hard disc recorder 1 as a remote controller. A display 7, which is configured by an LCD or LEDs (Light Emitting Diodes) are further provided, for example, on the front panel of the hard disc recorder 1 so that substance of the instruction selected by the user, operation mode of the hard disc recorder 1, current time, and so on can be displayed. The hard disc recorder 1 still further comprises an imaging unit (imaging means) 8 such as a camera inside, and a main controller 3 that controls entire of the hard disc recorder 1.

The main controller 3 comprises a CPU (Central Processing Unit) that executes predetermined programs so as to control each part of the hard disc recorder 1, a RAM (Random Access Memory) that is used as a work memory of the CPU, a ROM (Read Only Memory) that stores the predetermined programs, and so on. The predetermined programs include control programs for performing recording and reproducing function of digital data on and from the hard disc drive 2, for performing preset recording.

The main controller 3 further serves as a user identification unit (user identification means) 3a, a user attribution adding unit (user attribution adding means) 3b and a file management unit (file management means) 3c, details of which are described later.

The imaging unit 8 includes an imaging device such as a CCD (Charge Coupled Device) or a CMOS (Complementary Metal Oxide Semiconductor) and is disposed on, for example, a front panel of the hard disc recorder so that an image of a predetermined imaging area in front of the front panel can be taken. In other words, the imaging unit 8 takes an image of a user who operates the hard disc recorder 1. The imaging unit 8 takes an image at a predetermine time interval and the image data taken by the imaging unit 8 are serially transmitted to the main controller 3. Alternatively, the imaging unit 8 may be configured as an independent module connected to the hard disc recorder with a wired or wireless communication. In such a case, the imaging area can optionally be set so as to take a fine image of the user.

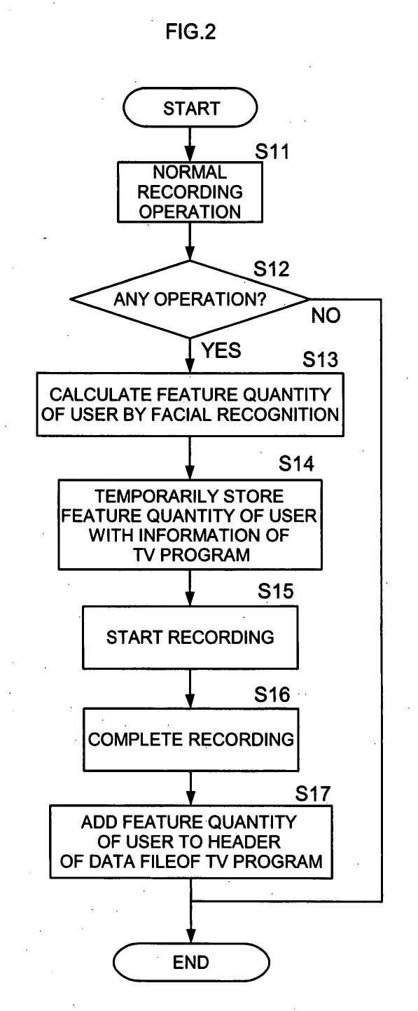

Subsequently, examples of recording operations of the hard disc recorder 1 are described. FIG. 2 shows an example of a normal recording operation where the hard disc recorder 1 starts to record a data file of TV program just when a user instructs to record a TV program.

When the user operates the operation unit 6 to instruct to start the recording of a TV program selected by the user (S11), the main controller 3 judges whether any one of reproducing operation, recording operation and time shift operation is performed or not (S12). When one of the reproducing operation, the recording operation and the time shift operation is performed, it is impossible to perform the recording operation furthermore, so that the main controller 3 cancels the normal recording operation instructed.

When no operation is performed, the main controller 3 serving as the user identification unit 3a performs a process of the facial recognition on the basis of an image data taken by the imaging unit 8 (S13). The user identification unit 3a identifies the user who instructs the recording operation by calculating a feature quantity of the user from the image data in the process of the facial recognition. When the user identification unit 3a calculates the feature quantity of the user, the main controller 3 serving as the user attribution adding unit 3b temporarily stores information of the feature quantity associated with information of a TV program to be recorded into the hard disc recorder 2 (S 14).

Subsequently, when the recording of the TV program is started (S 15), video signals extracted by the tuner 4 are converted and to digital signals and the digital signals are encoded and compressed in the signal processor 5, and the encoded and compressed digital data are serially recorded into the hard disc drive 2 as a temporary data file. When the user instructs to finish the recording operation while recording or when an end time of the TV program selected by the user comes, the main controller 3 completes the recording operation (S16). When the recording operation is completed, the user attribution adding unit 3b adds the information of the feature quantity which is temporarily stored to a header of the temporary data file and records the temporary data file into the hard disc recorder 2 as a data file of TV program (S17). Thereby, the attribution of the information of the user who records the TV program can be added to the data file of TV program.

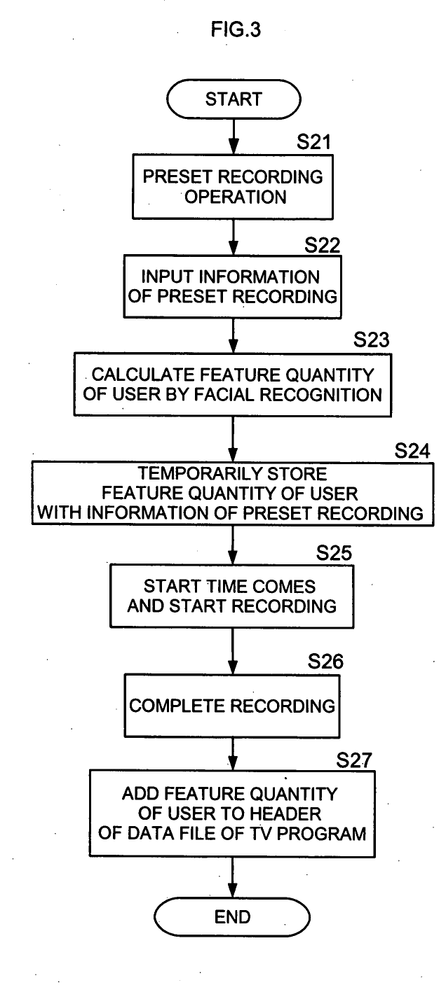

FIG. 3 shows an example of a preset recording operation where the hard disc recorder 1 starts to record a data file of TV program when a preset time to start the recording of a TV program set by a user comes.

When the user operates the operation unit 6 to instruct the preset recording of a TV program selected by the user (S21), information relating to the preset recording such as a preset time to start the recording, a TV program to be recorded, a quality of images of the TV -program to be recorded, and so on is inputted to the main controller 3 through the operation unit 6 (S22).

When the information relating to the preset recording is inputted, the user identification unit 3a calculates a feature quantity of the user who instructs the preset recording on the basis of an image data taken by the imaging unit 8 in the process of the facial recognition (S23). The user attribution adding unit 3b temporarily stores information of the feature quantity associated with the information relating to the preset recording into the hard disc recorder 2 (S24).

When the preset start time comes, the main controller 3 starts to record the TV program (S25). When the end time of the TV program comes, the main controller 3 completes the recording operation (S26), and the user attribution adding unit 3b adds the information of the feature quantity which is temporarily stored to a header of a data file of the TV program and records the data file of TV program into the hard disc recorder 2 (S27).

The main controller 3 serving as the file management unit 3c performs various file processing to the data files of TV programs recorded in the hard disc drive 2 on the basis of the instruction by the user. As for the file processing, a reproducing process to read out a data file of TV program from the hard disc recorder 2, an erasing process to erase a data file of TV program from the hard disc recorder 2, an editing process to divide a data file of TV program into two or more data files of TV program each having a shorter recording time, and so on are exemplified. In the reproducing process, the file management unit 3c reads out a data file of TV program selected by a user from the hard disc drive 2, and the signal processor 5 decodes the data file of TV program to video signals through digital signals. The video signals are outputted to the monitor display apparatus 20 through output terminals (not shown), so that the user can view the TV program which was recorded in the hard disc recorder 1 and by displaying images of the TV program on a screen of the monitor display apparatus 20.

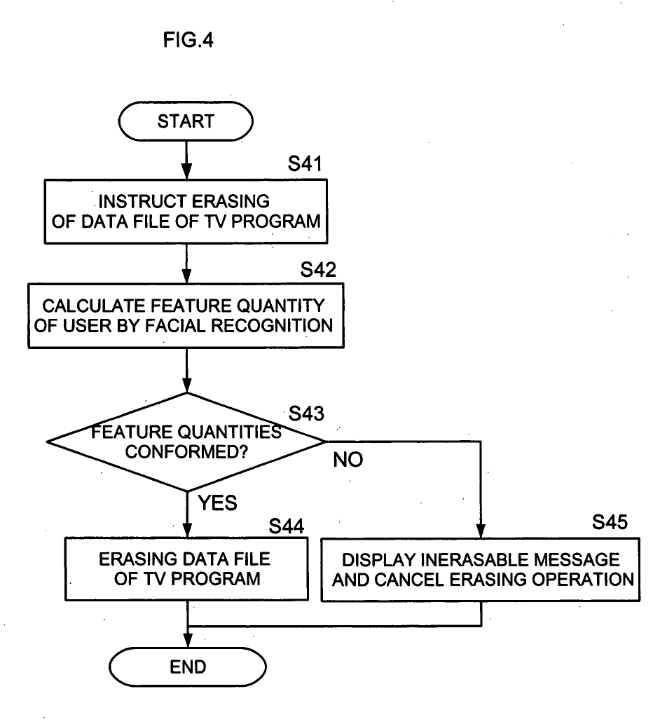

The file management unit 3c performs the erasing process of the data file of TV program only when the user who instructs to erase a TV program conforms to the user who instructed to record the TV program. FIG. 4 shows a flow of the erasing process by the file management unit 3.

When the user instructs to erase a TV program (S41), the imaging unit 8 takes an image data of the user, and the user identification unit 3a calculates a feature quantity of the user on the basis of the image data taken by the imaging unit 8 (S42). Then, the user identification unit 3a judges whether information of calculated feature quantity conforms to the information of the feature quantity included in the header of the data file of TV program to be erased, or not (S43). When the feature quantities of the users conform to each other (YES in step S43), the file management unit 3c erases the data file of TV program from the hard disc recorder 2 (S44). Alternatively, when the feature quantities of the users do not conform to each other (NO in step S43), the user identification unit 3a displays an inerasable message to the user so as to inform that the user who instructs to erase the TV program is different from the user who recorded the TV program on the display 7, or the erasing operation will be canceled, and the data management unit 3c cancels the instruction to erase the data file of TV program (S45).

According to the hard disc recorder 1, when a user instruct to record a TV program, a feature quantity of the user is calculated by the user identification unit 3a on the basis of an image data of the user taken by the imaging unit 8, and the user attribution adding unit 3b automatically adds information of the feature quantity of the user who instruct to record the TV program to a header of a data file of the TV program as an attribution of the user, with no requirement of operation to the user so as to add the attribution of the user. Therefore, even when the hard disc recorder 1 is used by a plurality of users, it is possible to manage the data files of TV programs recorded in the hard disc recorder 1 for each user, easily.

Furthermore, the information of the user such as the feature quantity of the user is included in each data file of TV program, so that it is no need to form a database to manage the user information, and thereby, the configuration of the hard disc recorder 1 can be simplified. Still furthermore, when the data file of TV program recorded in the hard disc recorder 1 is transmitted to another recording medium, the information of the user can be used. Still furthermore, when the user operates the operation unit 6 to erase a TV program recorded in the hard disc recorder 1, the user identification unit 3a compares the feature quantity of the user who operates the operation unit 6 with the feature quantity of the user included in the data file of the TV program, and when the feature quantities of the users do not conform to each other, the file management unit 3c does not erase the data file of the TV program from the hard disc recorder 1. Thus, it is possible to prevent that any data file of TV program recorded in the hard disc recorder 1 is erroneously erased by a user other than the user who records the TV program.

The present invention is not limited to the above mentioned embodiment, so that it is possible to apply various modifications in the purpose of the invention. For example, the user identification unit 3a may calculate the feature quantity of the user who instruct any operation other than the erasing operation, and judge whether the feature quantity of the user conforms to the feature quantity included in the data file of TV program or not, and the file management unit 3c may change the process of the instructed operation when the feature 0quantities do not conform to each other from the process when the feature quantities conform to each other. For example, when a user instructs to edit a data file of TV program, the editable items may be restricted or the editing operation may be canceled, if the feature quantity of the user who instructs to edit the data file of TV program does not conform to the feature quantity included in the data file of TV program. Furthermore, when a user instructs to reproduce a data file of TV program, the reproducible time may be restricted or the reproducing operation may be canceled corresponding to the identified user, if the feature quantity of the user who instructs to reproduce the TV program does not conform to the feature quantity included in the data file of TV program. By such modification, the hard disc recorder 1 can be used conveniently by a plurality of users.

This application is based on Japanese patent application 2006-029830 filed Feb. 7, 2006 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A hard disc recorder, which records digital audio and video signals into a hard disc drive, reproduces the digital audio and video signals from the hard disc drive, and outputs the digital audio and video signals to an external monitor display apparatus, comprising:
an imaging means that takes an image of a predetermined imaging area in front of the hard disc recorder and outputs an image data of the image;
a user identification means that calculates a feature quantity of a user who operates the hard disc recorder based on the image data by performing facial recognition, and identifies the user who operates the hard disc recorder;
a user attribution adding means that adds the feature quantity calculated by the user identification means to a data file of TV program to be recorded in the hard disc recorder when a user instructs to record a TV program; and
a file management means that manages data files of TV programs recorded in the hard disc recorder corresponding to the operation by the user.

2. The hard disc recorder in accordance with claim 1, wherein
the file management means performs different operation corresponding to the user identified by the user identification means, even when the operation instructed by the user is the same.

3. The hard disc recorder in accordance with claim 1, wherein
when a user instructs to erase a data file of TV program, the user identification means compares the feature quantity of the user who instructs to erase the data file of TV program with a feature quantity included in the data file of TV program;
when the feature quantity of the user conforms to the feature quantity included in the data file of TV program, the file management means erases the data file of TV program from the hard disc recorder; and
when the feature quantity of the user does not conform to the feature quantity included in the data file of TV program, the file management means does not erase the data file of TV program from the hard disc recorder.

4. The hard disc recorder in accordance with claim 3 further comprising a display means is further comprised, and wherein
when the feature quantity of the user does not conform to the feature quantity included in the data file of TV program, the file management means displays a predetermined inerasable message to the user so as to inform that erasing operation will be canceled through the display means.

5. The hard disc recorder in accordance with claim 2, wherein
when a user instructs to edit a data file of TV program, editable items are restricted or the editing operation is canceled, when the feature quantity of the user who instructs to edit the data file of TV program does not conform to the feature quantity included in the data file of TV program.

6. The hard disc recorder in accordance with claim 2, wherein
when a user instructs to reproduce a data file of TV program, reproducible time is restricted or reproducing operation is canceled corresponding to the identified user, when the feature quantity of the user who instructs to reproduce the TV program does not conform to the feature quantity included in the data file of TV program.

7. A hard disc recorder comprising:
a hard disc drive into which data files of TV programs are recorded;
a tuner that receives television broadcast signals delivered from a television station and extracts television broadcast signals of a desired channel among television broadcast signals of a plurality of television stations which are inputted through an external antenna, and outputs video signals including audio signals and visual signals;
a signal processor that converts the video signals outputted from the tuner or video signals inputted from external audio and visual apparatus through external input terminals to digital signals, encodes and compresses the digital signals, decodes the digital data read out from the hard disc drive to reproduce the original digital signals, and converts the decoded digital signals to analogue signals, and outputs the analogue signals to an external monitor display apparatus through output terminals;
an operation unit, which are operated by a user to select a channel of a television program to be received, to instruct at least to recording or reproducing the television program, or to set a preset time to start recording the television program;
a display that displays at least substance of the instruction by the user, and a predetermined message to the user;
an imaging unit including an imaging device that takes an image of a predetermined imaging area in front of the front panel of the hard disc recorder and outputs an image data of the image;
a user identification unit that calculates a feature quantity of a user who operates the hard disc recorder based on the image data by performing facial recognition, and identifies the user who operates the hard disc recorder;
a user attribution adding unit that adds the feature quantity calculated by the user identification unit to a data file of TV program to be recorded in the hard disc recorder when a user instructs to record a TV program; and
a file management unit that manages data files of TV programs recorded in the hard disc recorder corresponding to the operation by the user.

8. The hard disc recorder in accordance with claim 7, wherein
when a user instructs to erase a data file of TV program, the user identification unit compares the feature quantity of the user who instructs to erase the data file of TV program with a feature quantity included in the data file of TV program;
when the feature quantity of the user conforms to the feature quantity included in the data file of TV program, the file management unit erases the data file of TV program from the hard disc recorder; and
when the feature quantity of the user does not conform to the feature quantity included in the data file of TV program, the file management unit does not erase the data file of TV program from the hard disc recorder.

9. The hard disc recorder in accordance with claim 8, wherein
when the feature quantity of the user does not conform to the feature quantity included in the data file of TV program, the file management unit displays a predetermined inerasable message to the user so as to inform that erasing operation will be canceled on the display.
